(19) United States
(12) Patent Application Publication
(10) Pub. No.: US 2025/0260064 A1
(43) Pub. Date: Aug. 14, 2025

(54) POWER STORAGE CELL

(71) Applicant: TOYOTA JIDOSHA KABUSHIKI KAISHA, Toyota-shi (JP)

(72) Inventor: Shinichiro ITO, Kosai-shi (JP)

(73) Assignee: TOYOTA JIDOSHA KABUSHIKI KAISHA, Toyota-shi (JP)

(21) Appl. No.: 18/955,989

(22) Filed: Nov. 22, 2024

(30) Foreign Application Priority Data
Feb. 14, 2024 (JP) 2024-020129

(51) Int. Cl. H01M 10/0585; H01M 4/02

(52) U.S. Cl. CPC H01M 10/0585; H01M 2004/021; H01M 2220/20

(57) ABSTRACT

A power storage cell using an electrolyte solution, wherein the power storage cell includes a first electrode mixture layer, a separator, and a second electrode mixture layer opposed to the first electrode mixture layer with the separator interposed therebetween, wherein a coating area of at least one of the first electrode mixture layer and the second electrode mixture layer is equal to or larger than 600 cm², the first electrode mixture layer includes a first general portion and a first wall portion surrounding the periphery of the first general portion, the first wall portion is provided so as to protrude toward the second electrode mixture layer side from the first general portion, and the second electrode mixture layer includes a second general portion and a thin portion formed to be thinner than the second general portion.

### CROSS-REFERENCE TO RELATED APPLICATION

This application claims priority to Japanese Patent Application No. 2024-020129 filed on Feb. 14, 2024, incorporated herein by reference in its entirety.

### BACKGROUND

### 1. Technical Field

The present disclosure relates to a power storage cell.

### 2. Description of Related Art

In recent years, technology that suppresses a decrease in output due to a shortage of an electrolyte solution (liquid shortage) and a decrease in charge and discharge performance at high speed is disclosed in Japanese Unexamined Patent Application Publication No. 2019-71226 (JP 2019-71226 A). JP 2019-71226 A discloses a power storage cell using polyvinylidene fluoride (PVdF) that is not in a crystallized state in an electrode active material layer (electrode mixture layer).

### SUMMARY

In recent years, an increase in capacity has been proceeding, and the area of the electrode mixture layer has been increasing along with this capacity increase. When a large-area battery (power storage cell) using an electrolyte solution is charged and discharged at a high rate, an extrusion force of the electrolyte solution greatly acts due to expansion and contraction of an active material of the electrode mixture layer. When the electrolyte solution is discharged to the outside of the electrode mixture layer, since the distance from the discharged liquid to a center portion of the electrode mixture layer is long, it becomes difficult for the electrolyte solution to return to the center portion. As a result, liquid shortage easily occurs, and a decrease in output can occur.

The present disclosure has been made in view of the problem, and an objective of the present disclosure is to provide a power storage cell that is able to suppress liquid shortage and suppress a decrease in output after high-rate charging and discharging.

A power storage cell based on the present disclosure is a power storage cell using an electrolyte solution. The power storage cell includes a first electrode mixture layer, a separator, and a second electrode mixture layer opposing the first electrode mixture layer with the separator interposed between the first electrode mixture layer and the second electrode mixture layer. A coating area of at least one of the first electrode mixture layer and the second electrode mixture layer is 600 cm² or more. The first electrode mixture layer includes a first general portion and a first wall portion that surrounds a periphery of the first general portion. The first wall portion is provided to protrude more to a second electrode mixture layer side than the first general portion. The second electrode mixture layer includes a second general portion and a thin portion formed thinner than the second general portion.

In the power storage cell based on the present disclosure, the second electrode mixture layer may partially surround a periphery of the second general portion and may include a second wall portion that protrudes more to a first electrode mixture layer side than the second general portion. The thin portion may be formed in a region at which the second wall portion is not provided at a peripheral edge portion of the second electrode mixture layer.

In the power storage cell based on the present disclosure, the density of the second wall portion may be higher than the density of the second general portion.

In the power storage cell based on the present disclosure, the first electrode mixture layer may be a negative electrode mixture layer. The second electrode mixture layer may be a positive electrode mixture layer. The second electrode mixture layer may be disposed to enter a space surrounded by the first wall portion.

In the power storage cell based on the present disclosure, the density of the first wall portion may be higher than the density of the first general portion.

According to the present disclosure, a power storage cell can be provided that is able to suppress liquid shortage and suppress a decrease in output after high-rate charging and discharging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view of a power storage cell according to an embodiment;

FIG. 2 is a cross-sectional view taken along II-II shown in FIG. 1;

FIG. 3 is a schematic plan view of the first electrode mixture layer of the power storage cell according to the embodiment;

FIG. 4 is a schematic plan view of the second electrode mixture layer of the power storage cell according to the embodiment;

FIG. 5 is a schematic view showing a first step of manufacturing the second electrode mixture layer according to the embodiment;

FIG. 6 is a schematic view showing a second step of manufacturing the second electrode mixture layer according to the embodiment;

FIG. 7 is a schematic view showing a third step of manufacturing the second electrode mixture layer according to the embodiment;

FIG. 8 is a diagram showing the validation test conditions; and

FIG. 9 is a diagram showing the results of a verification experiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

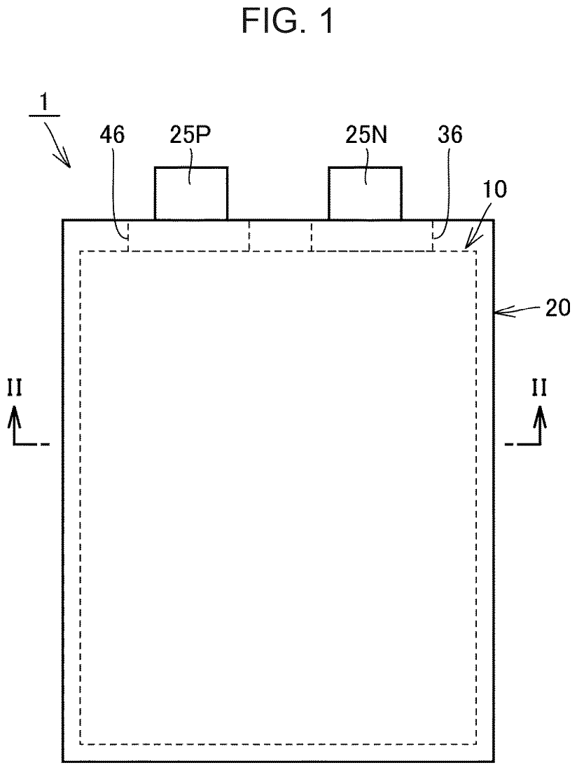

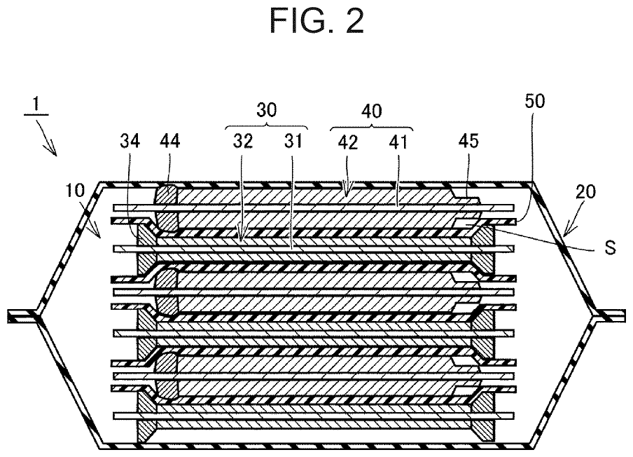

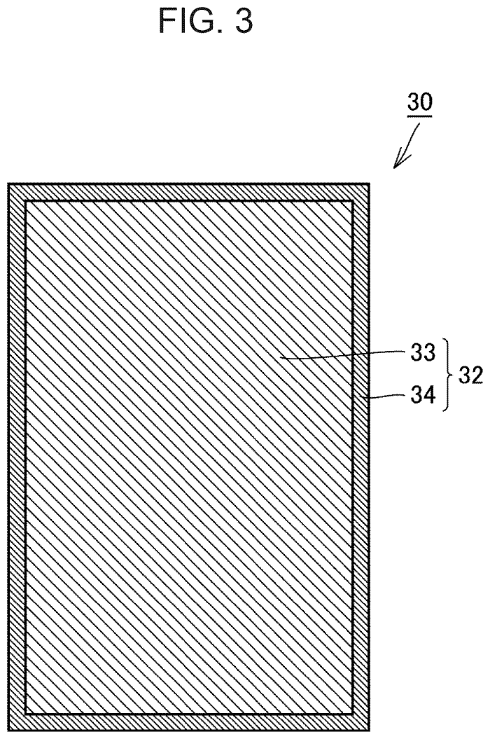

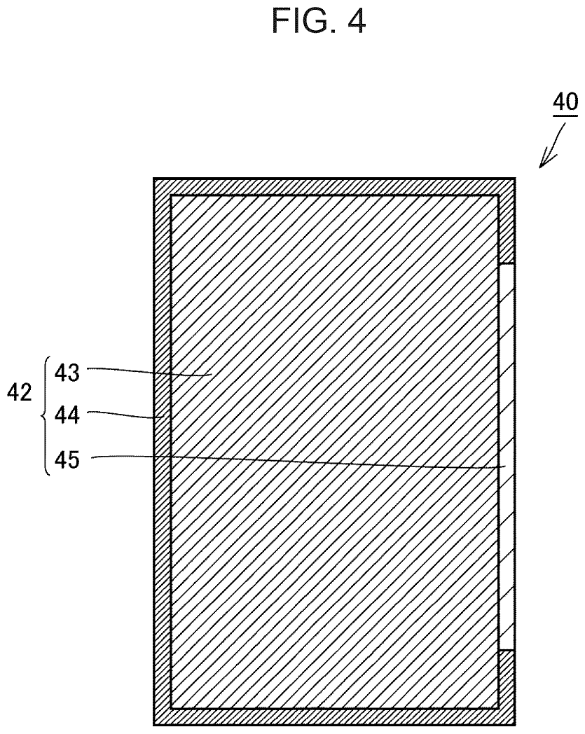

FIG. 1 is a schematic plan view of a power storage cell according to an embodiment. FIG. 2 is a cross-sectional view taken along II-II shown in FIG. 1. FIG. 3 is a schematic plan view of the first electrode mixture layer of the power storage cell according to the embodiment. FIG. 4 is a schematic plan view of the second electrode mixture layer of the power storage cell according to the embodiment. Referring to FIG. 1 to FIG. 4, a power storage cell 1 according to an embodiment will be described.

The power storage cell 1 is a vehicle-driven battery. The power storage cell 1 is mounted on, for example, a hybrid electric vehicle using an internal combustion engine such as a gasoline engine or a diesel engine and a motor supplied with electric power from a chargeable/dischargeable battery as a power source, a plug-in hybrid electric vehicle, battery electric vehicle capable of external charge, or the like.

In the present embodiment, the case where the power storage cell 1 is a laminated type liquid-based battery is described as an example, but the disclosure is not limited to the laminated type, and may be a rectangular tube type liquid-based battery. That is, the exterior body 20 described later may be formed of a rectangular tube-shaped metal member.

As illustrated in FIG. 1 and FIG. 2, the power storage cell 1 includes an electrode body 10, an exterior body 20, a first electrode terminal 25N, and a second electrode terminal 25P. For example, the first electrode terminal 25N is a negative electrode terminal, and the second electrode terminal 25P is a positive electrode terminal.

The exterior body 20 houses the electrode body 10 and the electrolyte solution. The exterior body 20 is formed of, for example, a laminate. The electrolyte solution is a non-aqueous one. The electrolyte solution includes, for example, a non-aqueous solvent and a support salt, such as a lithium salt, that produces charge carriers. Instead of the electrolyte solution, a polymer-like (gel-like) electrolyte or a solid-like electrolyte may be used.

The electrode body 10 is a so-called laminated electrode body, and includes a plurality of first electrodes 30, a plurality of second electrodes 40, and a plurality of separators 50. For example, the first electrodes 30 are negative electrodes, and the second electrodes 40 are positive electrodes. The electrode body 10 is formed by stacking the first electrode 30 and the second electrode 40 with the separator 50 interposed therebetween. Note that one or more first electrodes 30 and one or more second electrodes 40 may be provided.

Each of the first electrodes 30 includes a first electrode current collector 31 and a first electrode mixture layer 32. The first electrode current collector 31 is provided in a sheet shape. The first electrode current collector 31 is a negative electrode current collector.

The first electrode current collector 31 has a rectangular main body and the first electrode tab 36 protruding from one side of the main body.

The first electrode tabs 36 are disposed so as to overlap each other when viewed from the stacking direction of the first electrodes 30 and the second electrodes 40. The first electrode tabs 36 are connected to the first electrode terminal 25N.

The first electrode current collector 31 is formed of, for example, a copper foil. A first electrode mixture layer 32 is provided on the surface of the first electrode current collector 31. More specifically, the first electrode mixture layer 32 is provided on each of both surfaces of the first electrode current collector 31 in the stacking direction. The first electrode mixture layer 32 is not provided in the first electrode tab 36. The first electrode mixture layer 32 is a negative electrode mixture layer.

As shown in FIG. 2 and FIG. 3, the first electrode mixture layer 32 includes a first general portion 33 and a first wall portion 34 surrounding the first general portion 33. The thickness of the first wall portion 34 is larger than that of the first general portion 33. The first wall portion 34 is provided so as to protrude toward a second electrode mixture layer 42, which will be described later, which faces the separator 50.

The density of the first wall portion 34 may be higher than the density of the first general portion 33. For example, the density of the first wall portion 34 is 10% or more higher than that of the first general portion 33.

The first electrode mixture layer 32 has a substantially rectangular shape when viewed from the stacking direction. The ratio of the lengths of the long side and the short side of the first electrode mixture layer 32 may be, for example, 65:35, but is not limited to such a ratio.

The coating area of the first electrode mixture layer 32 is larger than the coating area of the second electrode mixture layer 42. The coating area of the first electrode mixture layer 32 is, for example, 600 cm² or more. More specifically, the coating area of the first electrode mixture layer 32 may be, for example, 600 cm² or more 9000 cm² or less. The coating area of the first electrode mixture layer 32 is slightly larger than the coating area of the second electrode mixture layer 42 described later. When viewed from the stacking direction, the outer edge of the first electrode mixture layer 32 is located outside the outer edge of the second electrode mixture layer 42. The basis weight of the first electrode mixture layer 32 is, for example, 20 mg/cm² or more.

The first electrode mixture layer 32 includes a first electrode active material. The first electrode active material is, for example, a material capable of absorbing and desorbing lithium ions. As the first electrode active material, for example, a carbon material such as graphite can be used.

Again, as shown in FIG. 1 and FIG. 2, each second electrode 40 includes a second electrode current collector 41 and a second electrode mixture layer 42. The second electrode current collector 41 is provided in a sheet shape. The second electrode current collector 41 is a positive electrode current collector. The second electrode current collector 41 includes a rectangular main body portion and the second electrode tab 46 protruding from one side of the main body portion.

The second electrode tabs 46 are disposed so as to overlap each other when viewed from the stacking direction of the first electrodes 30 and the second electrodes 40. The second electrode tabs 46 are connected to the second electrode terminal 25P.

The second electrode current collector 41 is formed of, for example, an aluminum foil or an aluminum alloy foil. A second electrode mixture layer 42 is provided on the surface of the second electrode current collector 41. More specifically, the second electrode mixture layer 42 is provided on each of both surfaces of the second electrode current collector 41 in the stacking direction. The second electrode mixture layer 42 is not provided in the second electrode tab 46. The second electrode mixture layer 42 faces the first electrode mixture layer 32 with the separator 50 interposed therebetween.

As shown in FIG. 2 and FIG. 4, the second electrode mixture layer 42 includes a second general portion 43, a second wall portion 44, and a thin portion 45. The second wall portion 44 partially surrounds the periphery of the second general portion 43. The thickness of the second wall portion 44 is larger than the thickness of the second general portion 43. The second wall portion 44 is provided so as to protrude toward the first electrode mixture layer 32 opposite to the separator 50.

The density of the second wall portion 44 may be higher than the density of the second general portion 43. For example, the density of the second wall portion 44 is 10% or more higher than that of the second general portion 43.

The thin portion 45 is formed thinner than the second general portion 43. The thin portion 45 is formed in a region not surrounded by the second wall portion 44. More specifically, the thin portion 45 is formed in a region of the peripheral edge portion of the second electrode mixture layer 42 where the second wall portion 44 is not provided. The second general portion 43 is surrounded by the thin portion 45 and the second wall portion 44. In the stacking direction, a gap S is provided between the thin portion 45 and the first electrode mixture layer 32, and excess electrolyte solution can be discharged into the gap S. The second electrode mixture layer 42 is disposed so as to enter a space surrounded by the first wall portion 34.

The second electrode mixture layer 42 has a substantially rectangular shape when viewed from the stacking direction. The ratio of the lengths of the long side and the short side of the second electrode mixture layer 42 may be, for example, 65:35, but is not limited to such a ratio.

The coating area of the second electrode mixture layer 42 is, for example, 600 cm² or more. More specifically, the coating area of the second electrode mixture layer 42 may be, for example, 2 or more of 600 cm² or more and 9000 cm² or less. The basis weight of the second electrode mixture layer 42 is, for example, 30 mg/cm² or more.

The second electrode mixture layer 42 includes a second electrode active material. The second electrode active material is, for example, a material capable of absorbing and desorbing lithium. As the second electrode active material, for example, lithium cobaltate (LiCoO₂), lithium manganate (LiMn₂O₄), lithium nickelate (LiNiO₂), or the like can be used. Further, as the second electrode active material, a lithium transition metal composite oxide such as a lithium nickel cobalt manganese composite oxide may be employed.

As shown in FIG. 2 again, the separator 50 is interposed between the first electrode 30 and the second electrode 40. The separator 50 insulates the first electrode mixture layer 32 and the second electrode mixture layer 42. As the separator 50, a resin-sheet such as polyethylene (PE) or polypropylene (PP) can be used.

Referring back to FIG. 1, the first electrode terminal 25N has one end and

the other end in a direction perpendicular to the stacking direction. One end of the first electrode terminal 25N is exposed from the exterior body 20. The other end of the first electrode terminal 25N is located inside the exterior body 20.

The other end of the first electrode terminal 25N is bonded to the first electrode tab 36. The joining may be performed by resistance welding, laser welding, ultrasonic welding, or the like. The first electrode terminal 25N is formed of a plate-shaped metallic member. Specifically, the first electrode terminal 25N is formed of a copper plate.

The second electrode terminal 25P has one end and the other end in a direction perpendicular to the stacking direction. One end of the second electrode terminal 25P is exposed from the exterior body 20. The other end of the second electrode terminal 25P is located inside the exterior body 20.

The other end of the second electrode terminal 25P is joined to the second electrode tab 46 by welding or the like. The joining may be performed by resistance welding, laser welding, ultrasonic welding, or the like. The second electrode terminal 25P is formed of a plate-shaped metallic member. Specifically, the second electrode terminal 25P is formed of an aluminum plate.

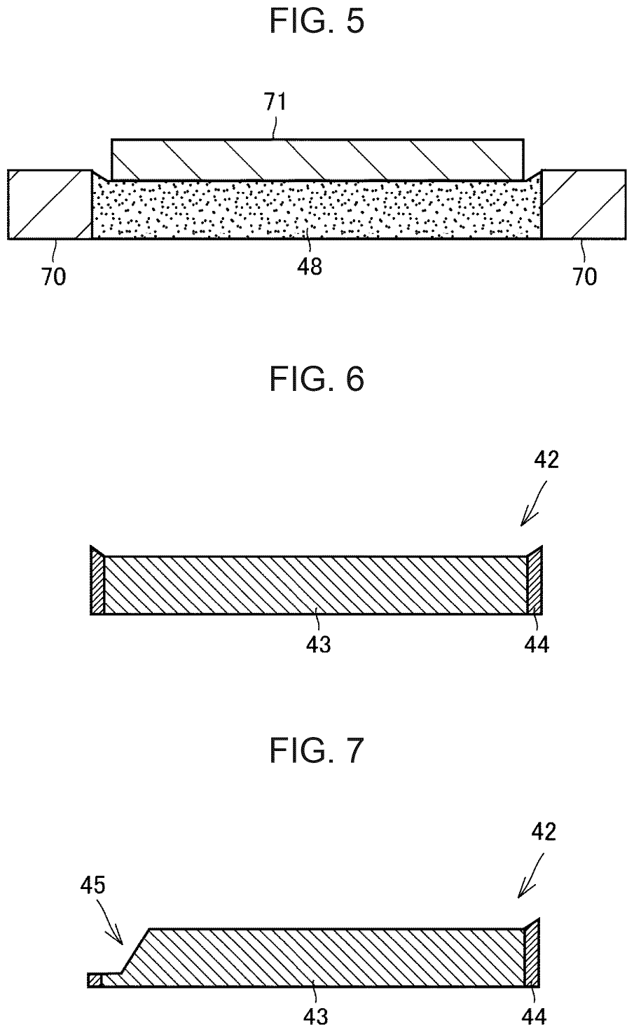

FIG. 5 to FIG. 7 are schematic views showing the first to third steps of manufacturing the second electrode mixture layer according to the embodiment. A method of manufacturing the second electrode mixture layer 42 will be described with reference to FIG. 5 to FIG. 7. In FIG. 5 to FIG. 7, the second electrode current collector 41 is omitted for convenience.

In manufacturing the second electrode mixture layer 42, as shown in FIG. 5, first, the frame member 70 is disposed on the surface of the second electrode current collector 41, and the second electrode slurry 48 is applied to the inside of the frame member using a coating apparatus. The coated second electrode slurry 48 is stretched with a squeegee 71. In the squeegee 71, a portion to be brought into contact with the second electrode slurry 48 is flat. By setting the viscosity of the second electrode slurry 48 to a predetermined value, the outer edge portion of the second electrode slurry 48 in contact with the frame member 70 by the surface tension becomes thicker than the central portion.

Subsequently, the second electrode slurry 48 whose surface shape has been adjusted is pressed. For example, the second electrode current collector 41 and the second electrode slurry 48 are sandwiched by a pressurizing device such as a pressurizing roller. As a result, as shown in FIG. 6, the second electrode mixture layer 42 is formed. More specifically, the thick film portion provided on the outer edge portion of the second electrode slurry 48 becomes the frame-shaped second wall portion 44, the other portion of the second electrode slurry 48 becomes the second general portion 43. The thickness of the frame-shaped second wall portion 44 is larger than that of the second general portion 43.

Subsequently, a portion of the frame-shaped second wall portion 44 is cut to form a thin portion 45 as shown in FIG. 7. In this manner, the second electrode mixture layer 42 is formed.

The first electrode mixture layer 32 is basically manufactured in accordance with the above-described manufacturing method, but the step of forming the thin portion 45 is omitted.

As described above, in the power storage cell 1 according to the present embodiment, the first wall portion 34 surrounding the first general portion 33 protrudes toward the second electrode mixture layer 42 side, and the second electrode mixture layer 42 includes the second general portion 43 and the thin portion 45. Thus, even when the coating area of at least one of the first electrode mixture layer 32 and the second electrode mixture layer 42 has a large area of 600 cm² or more, the excess electrolyte solution can be pushed out into the gap between the thin portion 45 and the first electrode mixture layer 32 when the electrode mixture layer shrinks. Further, since the first wall portion having a thickness larger than that of the general portion is provided, the extruded electrolyte solution can be stored inside the first wall portion. As a result, the electrolyte solution can be quickly re-supplied to the electrode mixture layer at the time of expansion of the electrode mixture layer. As a result, it is possible to suppress liquid shortage and to suppress a decrease in output after high-rate charging and discharging.

Further, the second electrode mixture layer 42 partially surrounds the periphery of the second general portion 43, and includes a second wall portion 44 protruding from the second general portion 43 toward the first electrode mixture layer 32 side, and the thin portion 45 is formed in a region where the second wall portion 44 is not provided. As a result, the electrolyte solution is less likely to be discharged beyond the second wall portion 44, so that the place where the excess electrolyte can be discharged can be limited to the thin portion 45. Therefore, the distance between the first electrode mixture layer 32 and the second electrode mixture layer 42 is suppressed from being increased when the electrolyte solution is discharged, and an increase in electrical resistance can be suppressed. As a result, a decrease in output can be suppressed.

In addition, by setting the density of the second wall portion to be higher than the density of the second general portion, the electrolyte solution is less likely to be discharged from the second wall portion 44 side to the outside, and the place where the excess electrolyte solution can be discharged can be further limited to the thin portion. As a result, it is possible to further suppress a decrease in output.

Further, since the second electrode mixture layer 42 is disposed so as to enter the space surrounded by the first wall portion 34, the distance between the first general portion of the first electrode mixture layer and the second general portion of the second electrode mixture layer can be made close, so that an increase in electrical resistance can be suppressed. As a result, a decrease in output can be suppressed.

Further, by setting the density of the first wall portion 34 to be higher than the density of the first general portion 33, the electrolyte is less likely to be discharged to the outside from the first wall portion 34 side, and the electrolyte solution is more likely to be stored inside the first wall portion 34.

### Verification Experiment

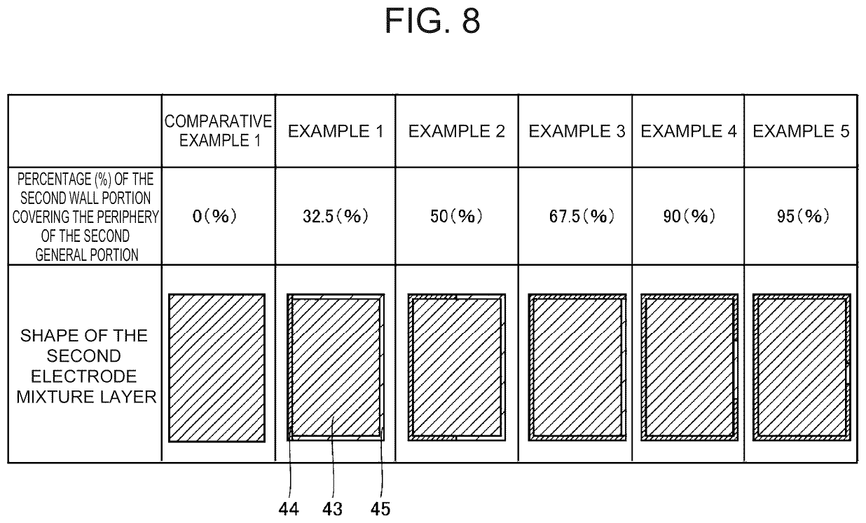

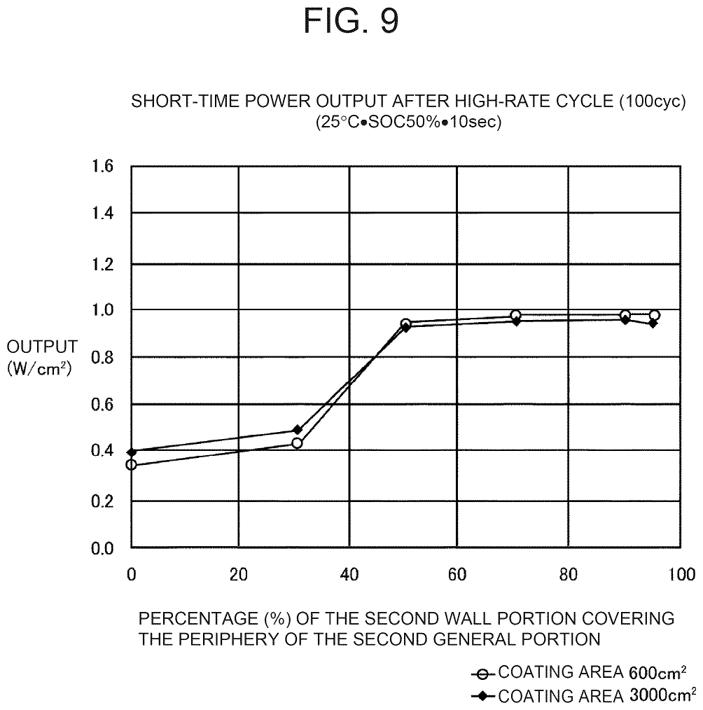

FIG. 8 is a diagram illustrating conditions of a verification experiment. FIG. 9 is a diagram showing the results of a verification experiment. A verification experiment will be described with reference to FIG. 8 and FIG. 9.

In the verification experiment, as shown in FIG. 8, the power storage cells according to Comparative Example 1 and Examples 1 to 5 were prepared, and the performance of each power storage cell was evaluated. Specifically, at an ambient temperature of 25° C., from SOC 0% to 100% was performed for 100 cycles at the current value of 2 C, and SOC 50% was set, and the output value calculated by the voltage-drop at the time of discharging at 4 C for 10 seconds was evaluated.

The capacitance of the respective power storage cells was set to 6000 mAh. In Comparative Example 1 and Examples, two types of power storage cells were prepared in which the coating area of the second electrode mixture layer (positive electrode mixture layer) was 600 cm², 3000 cm². The coating area of the first electrode mixture layer (negative electrode mixture layer) was substantially the same as that of the second electrode mixture layer. The basis weight of the first electrode (negative electrode) was 20 mg/cm², and the basis weight of the second electrode (positive electrode) was 30 mg/cm².

As the power storage cells according to Comparative Example 1 and Examples 1 to 5, those in which the ratio of the second wall portion 44 of the second electrode mixture layer 42 surrounding the periphery of the second general portion 43 was different were prepared.

As shown in FIG. 8 and FIG. 9, in Comparative Example 1, as the second electrode mixture layer, the second wall portion 44 was not provided, and only the second general portion 43 was used. That is, the ratio of the second wall portion 44 covering the periphery of the second general portion 43 was set to 0%. Further, as the first electrode mixture layer, the first wall portion 34 is not provided, and only the second general portion 43 is used.

In Comparative Example 1, when the coating area of the second electrode mixture layer 42 was set to 600 cm², the power obtained by the above evaluation was approximately 0.36 W/cm². When the coating area of the second electrode mixture layer 42 was 3000 cm², it was approximately 0.40 W/cm².

In Example 1, as the second electrode mixture layer, the ratio of the second wall portion 44 covering the periphery of the second general portion 43 was set to 32.5%. In the second electrode mixture layer, 65% of the periphery of the second general portion 43 was a thin portion 45. As the first electrode mixture layer 32, a material in which the first wall portion 34 surrounds the entire circumference of the first general portion 33 was prepared. The density of the first wall portion 34 was higher than the density of the first general portion 33, and the density of the second wall portion 44 was higher than the density of the second general portion 43.

In Example 1, when the coating area of the second electrode mixture layer 42 was set to 600 cm², the above-described evaluations resulted in approximately 0.43 W/cm². When the coating area of the second electrode mixture layer 42 was 3000 cm², it was approximately 0.50 W/cm².

In Example 2, as the second electrode mixture layer, the ratio of the second wall portion 44 covering the periphery of the second general portion 43 was set to 50%. In the second electrode mixture layer, 50% of the periphery of the second general portion 43 was a thin portion 45. As the first electrode mixture layer 32, a material in which the first wall portion 34 surrounds the entire circumference of the first general portion 33 was prepared. The density of the first wall portion 34 was higher than the density of the first general portion 33, and the density of the second wall portion 44 was higher than the density of the second general portion 43.

In Example 2, when the coating area of the second electrode mixture layer 42 was set to 600 cm², the above-described evaluations resulted in approximately 0.94 W/cm². When the coating area of the second electrode mixture layer 42 was 3000 cm², it was approximately 0.96 W/cm².

In Example 3, as the second electrode mixture layer, the ratio of the second wall portion 44 covering the periphery of the second general portion 43 was set to 67.5%. In the second electrode mixture layer, 50% of the periphery of the second general portion 43 was a thin portion 45. As the first electrode mixture layer 32, a material in which the first wall portion 34 surrounds the entire circumference of the first general portion 33 was prepared. The density of the first wall portion 34 was higher than the density of the first general portion 33, and the density of the second wall portion 44 was higher than the density of the second general portion 43.

In the third embodiment, when the coating area of the second electrode mixture layer 42 was set to 600 cm², the above-described evaluations resulted in approximately 0.97 W/cm². When the coating area of the second electrode mixture layer 42 was 3000 cm², it was approximately 0.98 W/cm².

In Example 4, as the second electrode mixture layer, the ratio of the second wall portion 44 covering the periphery of the second general portion 43 was set to 90%. In the second electrode mixture layer, 90% of the periphery of the second general portion 43 was a thin portion 45. As the first electrode mixture layer 32, a material in which the first wall portion 34 surrounds the entire circumference of the first general portion 33 was prepared. The density of the first wall portion 34 was higher than the density of the first general portion 33, and the density of the second wall portion 44 was higher than the density of the second general portion 43.

In Example 4, when the coating area of the second electrode mixture layer 42 was set to 600 cm², the above-described evaluations resulted in approximately 0.97 W/cm². When the coating area of the second electrode mixture layer 42 was 3000 cm², it was approximately 0.98 W/cm².

In Example 5, as the second electrode mixture layer, the ratio of the second wall portion 44 covering the periphery of the second general portion 43 was set to 95%. In the second electrode mixture layer, 90% of the periphery of the second general portion 43 was a thin portion 45. As the first electrode mixture layer 32, a material in which the first wall portion 34 surrounds the entire circumference of the first general portion 33 was prepared. The density of the first wall portion 34 was higher than the density of the first general portion 33, and the density of the second wall portion 44 was higher than the density of the second general portion 43.

In Example 5, when the coating area of the second electrode mixture layer 42 was set to 600 cm², the power obtained by the above-described assessment was approximately 0.97 W/cm². When the coating area of the second electrode mixture layer 42 was 3000 cm², it was approximately 0.98 W/cm².

In any of Examples 1 to 5, in comparison with Comparative Example 1, when the coating area of the second electrode mixture layer 42 was 600 cm², the above-mentioned power was increased in both cases where the coating area of the second electrode mixture layer 42 was 3000 cm². That is, it was confirmed that the first wall portion 34 protrudes toward the second electrode mixture layer 42 side from the first general portion 33, and the second electrode mixture layer includes a thin portion, so that a decrease in output after high-rate charging and discharging can be suppressed.

Further, by forming the thin portion 45, it is possible to form a space between the thin portion 45 and the first electrode mixture layer 32 in the lamination direction. From the above results, it was confirmed that excess electrolyte solution was discharged into the space and the discharged electrolyte solution could be stored inside the first wall portion 34 of the first electrode mixture layer 32. As described above, since the electrolyte solution can be held in the vicinity of the electrode, it is possible to quickly discharge and supply the electrolyte against the expansion and contraction of the electrode mixture layer.

In addition, it was confirmed that, by setting the coating area of the second electrode mixture layer 42 to be equal to or larger than 600 cm², it was possible to suppress the drop in power after high-rate charging and discharging.

Further, Example 2 to Example 5, the output is increased than in Example 1, the ratio of the second wall portion 44 covers the periphery of the second general portion 43 by 50% or more and 95% or less, it was confirmed that the output decrease after high-rate charging and discharging can be further suppressed.

The embodiments disclosed herein are illustrative and not restrictive in all respects. The scope of the present disclosure is defined by the claims, and includes all modifications within the meaning and range equivalent to the claims.

What is claimed is:

1. An power storage cell that uses an electrolyte solution, the power storage cell comprising:
a first electrode mixture layer;
a separator; and
a second electrode mixture layer opposing the first electrode mixture layer with the separator interposed between the first electrode mixture layer and the second electrode mixture layer, wherein
a coating area of at least one of the first electrode mixture layer and the second electrode mixture layer is 600 cm² or more,
the first electrode mixture layer includes a first general portion and a first wall portion that surrounds a periphery of the first general portion,
the first wall portion is provided to protrude more to a second electrode mixture layer side than the first general portion, and
the second electrode mixture layer includes a second general portion and a thin portion formed thinner than the second general portion.

2. The power storage cell according to claim 1, wherein:
the second electrode mixture layer partially surrounds a periphery of the second general portion and includes a second wall portion that protrudes more to a first electrode mixture layer side than the second general portion; and
the thin portion is formed in a region at which the second wall portion is not provided at a peripheral edge portion of the second electrode mixture layer.

3. The power storage cell according to claim 2, wherein a density of the second wall portion is higher than a density of the second general portion.

4. The power storage cell according to claim 1, wherein:
the first electrode mixture layer is a negative electrode mixture layer;
the second electrode mixture layer is a positive electrode mixture layer; and
the second electrode mixture layer is disposed to enter a space surrounded by the first wall portion.

5. The power storage cell according to claim 1, wherein a density of the first wall portion is higher than a density of the first general portion.
